(19) United States
(12) Patent Application Publication
(10) Pub. No.: US 2026/0337515 A1
(43) Pub. Date: Oct. 29, 2026

(54) MULTI-WORKING-CONDITION ADAPTIVE FULLY SYNTHETIC CUTTING FLUID AND PREPARATION METHOD THEREFOR

(71) Applicants: HAIXI (FUJIAN) INSTITUTE, CHINA ACADEMY OF MACHINERY SCIENCE & TECHNOLOGY GROUP, Sanming, Fujian (CN); CHINA MACHINERY FOUNDRY MATERIAL TECHNOLOGY (FUJIAN) CO., LTD., Sanming, Fujian (CN)

(72) Inventors: Wen Zhan, Sanming, Fujian (CN); Yingpeng Li, Sanming, Fujian (CN); Huixian Lin, Sanming, Fujian (CN); Rong Chen, Sanming, Fujian (CN); Long Pan, Sanming, Fujian (CN); Yutao Zhang, Sanming, Fujian (CN)

(21) Appl. No.: 19/124,337

(22) PCT Filed: Nov. 25, 2022
(86) PCT No.: PCT/CN2022/134431

§ 371 Date: Apr. 25, 2025

(30) Foreign Application Priority Data
Oct. 27, 2022 (CN) 202211325542.7

(51) Int. Cl. C10M 173/00; C10M 105/32; C10M 125/26; C10M 129/16; C10M 129/42; C10M 129/56; C10M 129/76; C10M 133/08; C10M 141/06; C10M 155/02; C10M 159/02; C10M 159/12; C10M 167/00; C10M 177/00; C10N 30/12; C10N 30/16; C10N 30/18; C10N 40/20; C10N 40/22; C10N 70/00

(52) U.S. Cl. CPC C10M 173/00; C10M 105/32; C10M 125/26; C10M 129/16; C10M 129/42; C10M 129/56; C10M 129/76; C10M 133/08; C10M 141/06; C10M 155/02; C10M 159/02; C10M 159/12; C10M 167/00; C10M 177/00; C10M 2201/02; C10M 2201/087; C10M 2207/046; C10M 2207/127; C10M 2207/284; C10M 2215/042; C10M 2215/08; C10M 2229/047; C10N 2030/12; C10N 2030/16; C10N 2030/18; C10N 2040/22; C10N 2040/245; C10N 2070/00

(57) ABSTRACT

A multi-working-condition adaptive fully synthetic cutting fluid and a preparation method therefor are provided. The cutting fluid includes in parts by weight: 12-20 parts of an organic alcohol amine, 1-3 parts of boric acid, 1-3 parts of dodecanedioic acid, 0.3-0.8 parts of ethylenediamine tetraacetic acid, 1-4 parts of a tricarboxylic acid antirust agent, 6-12 parts of an amidation-modified unsaturated fatty glyceride, 2-8 parts of an emulsified lubricant, 0.2-0.8 parts of a combined corrosion inhibitor, 0.5-3 parts of a sterilizing agent, 0.1-0.5 parts of a polyether modified silicone defoaming agent and 50-75 parts of water. The preparation method for the fully synthetic cutting fluid is further provided.

### TECHNICAL FIELD

The present disclosure relates to the field of multi-working-condition fully synthetic cutting fluids. More specifically, the present disclosure discloses a multi-working-condition fully synthetic cutting fluid and a preparation method therefor.

### BACKGROUND ART

The cutting fluid, a necessary condition for achieving precision, high efficiency and low cost in metal processing, is a consumable auxiliary material with large use amount and wide application range. The cutting fluid may be divided into an oil-based cutting fluid and a water-based cutting fluid according to compositions thereof. The oil-based cutting fluid does not need to be diluted when used, and has better lubricating property but poor cooling effect compared with the water-based cutting fluid. Meanwhile, since the addition amount of base oil reaches 50~90%, it has limitations such as easy corruption and deterioration, difficult waste liquid treatment and high use cost. The water-based cutting fluid may be divided into emulsion, microemulsion and fully synthetic fluid according to the morphology of the diluted solution thereof. The fully synthetic cutting fluid has been widely used and studied because of its excellent lubrication, cooling, cleaning, rust inhibition and corrosion inhibition.

In recent years, with the rapid development of the mechanical processing and manufacturing industry, the processing of a single product or a single material has become relatively rare. The same machine tool needs to process a variety of metals and parts. If different cutting fluids are used, the purchase, replacement and equipment maintenance costs may increase, and simultaneously, the production efficiency may be reduced to a certain extent. The multi-working-condition adaptive cutting fluid means “general use/universal” and “combined use”, that is, for the diversity and complexity of modern metal cutting processes, the use of one kind of cutting fluid can meet the various processing requirements of two or more metals.

Chinese patent with issue number CN109337751B discloses a universal cutting fluid, having following components: 300-400 parts of mineral oil, 65-73 parts of vegetable oleic acid, 40-60 parts of alcohol amine, 102-160 parts of preservative, 55-80 parts of surfactant, 2-6 parts of couplant, 5-10 parts of sterilizing agent, 1-3 parts of defoaming agent, and 400-500 parts of water. The cutting fluid does not contain nitrite and sulfide, has excellent resistance to hard water, and can be used in a variety of processes of CNC, gantry CNC, drilling machine and grinding machine. However, the added 150 SN mineral oil-based lubricant oil thereof belongs to Group I mineral base oil, has a biodegradability index (BDI) value of 42.3%, and belongs to difficult biodegradable substances. Meanwhile, it is easily affected by various external factors, and very easy to breed bacteria, causing the cutting fluid to corrupt and deteriorate, and resulting in service defects such as short service life and high waste fluid treatment cost.

Chinese invention patent with publishment number CN104403769A discloses a multifunctional cutting fluid and a preparation method therefor, the components thereof being as follows: 30%-40% of mineral oil, 5%-12% of triethanolamine, 3%-8% of lauryl alcohol polyoxyethylene ether, 10%-15% of rust inhibitor, 1%-5% of lubricant, 1%-3% of sterilizing agent, 0.5%-1% of corrosion inhibitor, 1%-3% of pH adjuster, and the remaining component water. The cutting fluid has excellent lubricating property and rust inhibition, and is effective in improving the surface finish of workpieces and reducing wear of a cutter. However, this cutting fluid has poor corrosion inhibition effect on active metals such as aluminum and magnesium.

### SUMMARY

In order to achieve these purposes and other advantages according to the present disclosure, in an aspect, a preferred embodiment of the present disclosure provides a multi-working-condition adaptive fully synthetic cutting fluid, including the following raw materials in parts by weight:
organic alcohol amine 12-20 parts
boric acid 1-3 parts
ethylenediamine tetraacetic acid 0.3-0.8 parts
dodecanedioic acid 1-3 parts
tricarboxylic acid rust inhibitor 1-4 parts
amidation-modified unsaturated fatty acid glyceride 6-12 parts
emulsified lubricant 2-8 parts
combined corrosion inhibitor 0.2-0.8 parts
sterilizing agent 0.5-3 parts
polyether modified silicone defoaming agent 0.1-0.5 parts
water 50-75 parts.

According to a preferred embodiment of the present disclosure, in the multi-working-condition adaptive fully synthetic cutting fluid, the organic alcohol amine consists of triethanolamine and monoethanolamine in a weight ratio of 1:0.2-0.4.

According to a preferred embodiment of the present disclosure, in the multi-working-condition adaptive fully synthetic cutting fluid, the weight ratio of the boric acid to the monoethanolamine is 1:1-1.5.

According to a preferred embodiment of the present disclosure, in the multi-working-condition adaptive fully synthetic cutting fluid, the emulsified lubricant is a self-emulsifying ester of fatty acid polyethylene glycol ester type having a molecular structure containing ester group and carboxyl group.

According to a preferred embodiment of the present disclosure, in the multi-working-condition adaptive fully synthetic cutting fluid, the combined corrosion inhibitor consists of by weight percentage: copper corrosion inhibitor benzotriazole 40%, and aluminum corrosion inhibitors octylphosphonic acid 30% and siloxane ketone 30%.

According to a preferred embodiment of the present disclosure, in the multi-working-condition adaptive fully synthetic cutting fluid, the sterilizing agent is one or more of Sandan oil (i.e., hexahydro-1,3,5-tris (hydroxyethyl)-s-triazine), parahydroxybenzoate ester and ethylene glycol hemiacetal.

In an aspect, a preferred embodiment of the present disclosure provides a preparation method for the multi-working-condition adaptive fully synthetic cutting fluid, including following steps:
Step A: taking and mixing, by weight parts, 12-20 parts of organic alcohol amine, 1-3 parts of boric acid, 0.3-0.8 parts of ethylenediamine tetraacetic acid, 1-3 parts of dodecanedioic acid, 1-4 parts of tricarboxylic acid rust inhibitor, and 15-30 parts of water, pouring into a reactor, heating to 50-80 °C, starting stirring with a stirring rotation speed of 70-200 rpm/min, and reacting for 30-60 min to obtain a mixture A;
Step B: mixing the mixture A prepared in Step A, 6-12 parts of amidation-modified unsaturated fatty acid glyceride, 2-8 parts of emulsified lubricant, and 0.2-0.8 parts of combined corrosion inhibitor, and stirring for 30-60 min at a stirring rotation speed of 70-200 rpm/min to obtain a mixture B; and
Step C: mixing the mixture B prepared in Step B, 0.5-3 parts of sterilizing agent, 0.1-0.5 parts of polyether modified silicone defoaming agent, and 35-45 parts of water, and stirring for 30-60 min at a stirring rotation speed of 70-200 rpm/min to obtain the target product, multi-working-condition adaptive fully synthetic cutting fluid.

The present disclosure has at least the following beneficial effects:
(1) For the cutting fluid of the present disclosure, unsaturated fatty acid glyceride is subjected to amidation modification to make it have excellent oxidation resistance, play lubricating and rust inhibition roles in the cutting fluid, and increase the service life of the cutting fluid.
(2) The emulsified lubricant in the traditional fully synthetic cutting fluid is mainly polyether, which generally has the problems of poor lubricating property, polyether precipitation and metal chip adhesion, and large difficulty in waste liquid treatment. The emulsified lubricant in the formula of the present disclosure is a self-emulsifying ester of fatty acid polyethylene glycol ester type containing ester group and carboxyl group. In the molecular structure of the self-emulsifying ester, due to the presence of a polar group at one end of the chain, the symmetry and charge distribution of its structure are changed, making it become a polar molecule with heterogeneous charges at two ends. During the metal cutting process, the polar molecules migrate through the cutting fluid to the metal-cutting fluid interface, and have their polar group ends forming a relatively strong adsorption film with the metal, and the other ends (CH₃) capable of fully “miscible due to the similarity” with the amidation-modified unsaturated fatty acid glyceride in the formula due to the similarity thereof in structure, thus forming a monomolecular adsorption film layer composed of polar molecules on the metal-cutting fluid interface. Due to the relatively weak binding energy of the CH₃ end, when the adsorption film layer is subjected to shearing, the CH₃ binding site fractures first and slides parallel to the interface, thereby reducing friction and exerting excellent lubricating properties. In addition, the self-emulsifying ester structure does not contain polyoxyethylene ether segments and elements such as sulfur, phosphorus, and chlorine, and when added to the cutting fluid, can make it have certain anti-foaming property and anti-hard water capability and adapt to various water quality conditions in different region and be green and environmentally friendly.
(3) In the present disclosure, the combined corrosion inhibitor includes the following components by weight percentage: copper corrosion inhibitor benzotriazole 40%, and aluminum corrosion inhibitors octylphosphonic acid 30% and siloxane ketone 30%. The combined corrosion inhibitor has a wide application range and has a good corrosion inhibition effect on active metals such as aluminum. In the above, organic alcohol amine is a rust inhibition additive commonly used for preparing the water-based cutting fluid, which has rust inhibition effect on steel and cast iron materials, but is corrosive to copper, aluminum and their alloys; while benzotriazole in the combined corrosion inhibitor of the present disclosure has good corrosion inhibition effect on copper and copper alloy, but basically has no corrosion inhibition effect on aluminum and its alloy. Therefore, the introduction of aluminum corrosion inhibitors octylphosphonic acid and siloxane ketone enables the corrosion inhibitor in the formula to have corrosion inhibition effect on copper, aluminum and their alloys at the same time.
(4) The prepared fully synthetic cutting fluid is a uniform liquid with no stratification or precipitation. The performance indexes of the diluted solution, such as lubricating property, rust inhibition, and defoaming property, all meet the technical requirements of synthetic cutting fluids (GB/T 6144-2010). Meanwhile, it contains no any toxic substances, does not pollute the environment, and reduces the subsequent disposal cost of waste cutting fluid.
(5) The present disclosure can meet the lubrication and corrosion inhibition requirements of mechanical processing forms such as CNC machine tools, gantry machining centers, grinding machines of ferrous metals, copper alloy, and aluminum alloy materials by adding amidation-modified unsaturated fatty acid glyceride and special emulsified lubricant (self-emulsifying ester of fatty acid polyethylene glycol ester type containing ester group and carboxyl group) and combining them with combined corrosion inhibitor (benzotriazole 40%, octylphosphonic acid 30%, and siloxane ketone 30%), and achieve the use effect of adaptability to multiple working conditions. Meanwhile, it contains no any toxic substances, does not cause harm to the environment, and has the application prospect of industrial large-scale production.

Other advantages, objectives and features of the present disclosure will be embodied partially through the following description, and partially be understood by those skilled in the art through study and practice of the present disclosure.

### BRIEF DESCRIPTION OF DRAWINGS

FIG. 1 is a schematic flow chart of a preparation method for a multi-working-condition adaptive fully synthetic cutting fluid in an embodiment of the present disclosure.

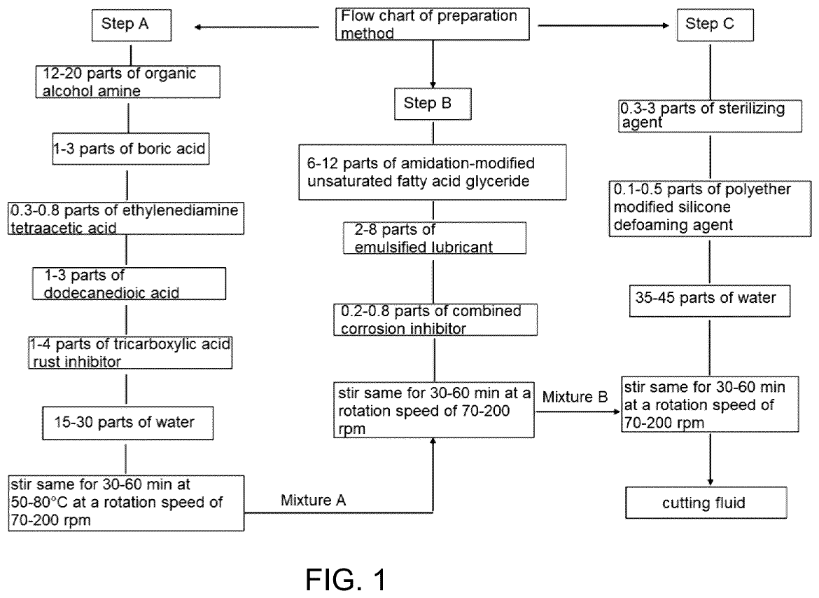

FIG. 2 is a schematic view of the molecular structure of a self-emulsifying ester in another embodiment of the present disclosure.

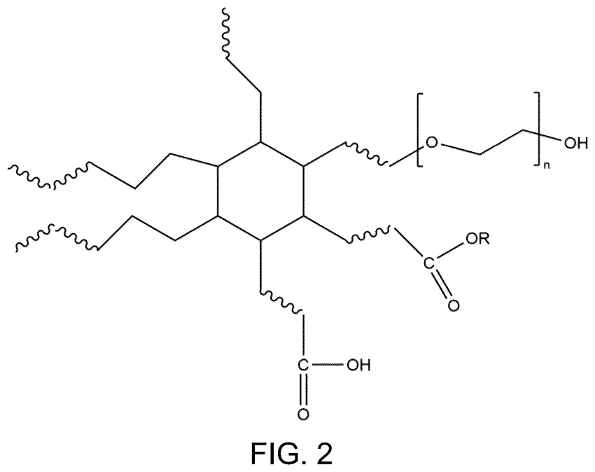

FIG. 3 shows pictures of LY12 aluminum corrosion tests of Examples 1 to 6 according to the present disclosure.

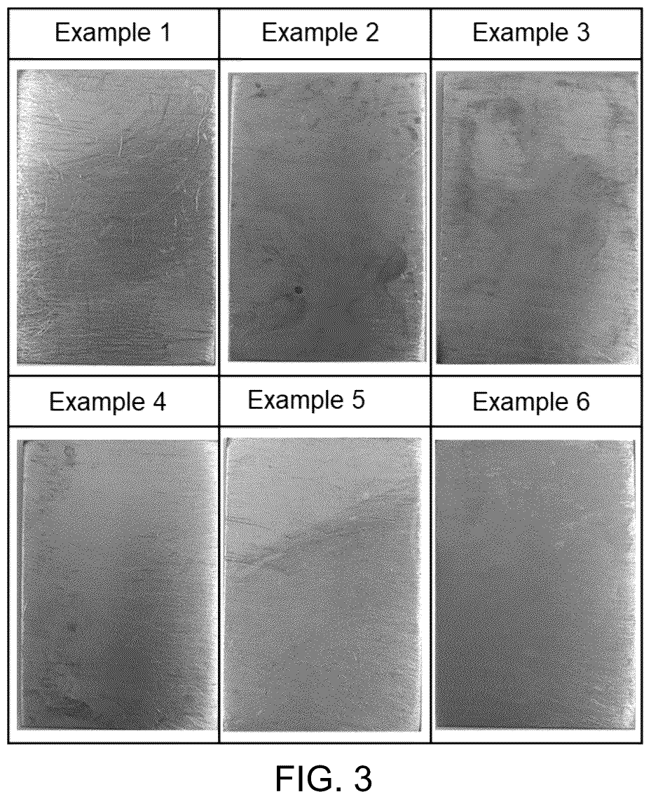

FIG. 4 shows pictures of LY12 aluminum corrosion tests of Comparative Example 1 and Comparative Example 2 according to the present disclosure.

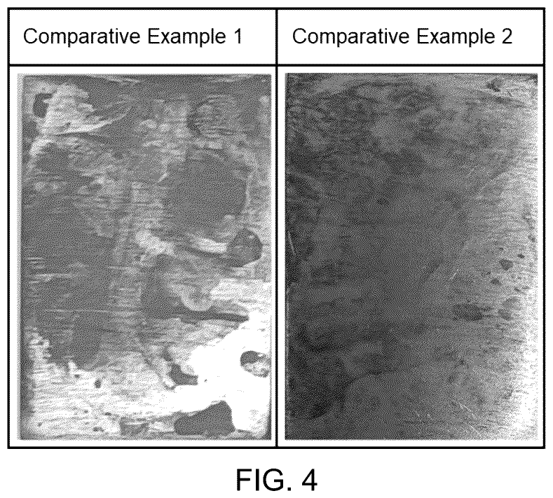

FIG. 5 shows a picture of the LY12 aluminum corrosion test of Comparative Example 3 according to the present disclosure.

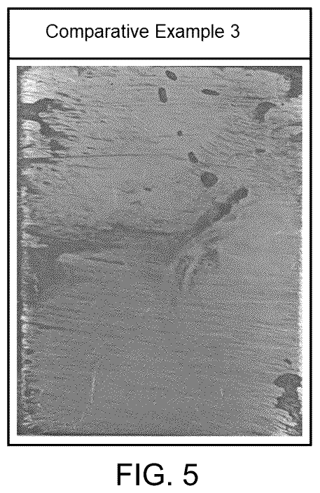

### DETAILED DESCRIPTION OF EMBODIMENTS

The present disclosure is further described in detail below in conjunction with the drawings so that it may be implemented by those skilled in the art according to the text of the description.

The following description is used to disclose the present disclosure so that those skilled in the art may implement the present disclosure. The preferred embodiments described below are only examples, and those skilled in the art may think of other obvious variations. The basic principles of the present disclosure defined in the following description may be applied to other embodiments, variations, improvements, equivalents, and other technical solutions that do not deviate from the spirit and scope of the present disclosure.

It is understandable that the term “one” should be understood as “at least one” or “one or more”. That is, in one embodiment, the number of an element may be one, while in another embodiment, the number of the element may be multiple, and the term “one” should not be understood as a limitation on the quantity.

### Example 1

This example provided a multi-working-condition adaptive fully synthetic cutting fluid, having the compositions shown in the following table.

TABLE 1
Compositions of Example 1

| Raw Material | Weight/g |
|---|---|
| Organic alcohol amine | 18 |
| Boric acid | 2 |
| Ethylenediamine tetraacetic acid | 0.5 |
| Dodecanedioic acid | 2 |
| Tricarboxylic acid rust inhibitor | 2 |
| Water | 20 |
| Amidation-modified unsaturated fatty acid glyceride | 8 |
| Self-emulsifying ester | 2 |
| Combined corrosion inhibitor | 0.2 |
| Sandan Oil | 0.5 |
| Polyether modified silicone defoaming agent | 0.1 |
| Water | 44.7 |

The organic alcohol amine, boric acid, ethylenediamine tetraacetic acid, dodecanedioic acid, tricarboxylic acid rust inhibitor, and water (20 g) in Table 1 were mixed, heated to 70 °C for reaction at a stirring rotation speed of 70 rpm/min. The reaction lasted for 30 min, and the heating was stopped. Subsequently, amidation-modified unsaturated fatty acid glyceride, self-emulsifying ester, and combined corrosion inhibitor were added thereto, mixed and stirred for 30 min at a stirring rotation speed of 70 rpm/min. After the reaction, Sandan oil, polyether modified silicone defoaming agent, and water (44.7 g) were added thereto, and continued to be stirred for 30 min to obtain Example 1.

### Example 2

This example provided a multi-working-condition adaptive fully synthetic cutting fluid, having the compositions shown in the following table.

TABLE 2
Compositions of Example 2

| Raw Material | Weight/g |
|---|---|
| Organic alcohol amine | 14 |
| Boric acid | 2.5 |
| Ethylenediamine tetraacetic acid | 0.4 |
| Dodecanedioic acid | 1.5 |
| Tricarboxylic acid rust inhibitor | 2 |
| Water | 24.1 |
| Amidation-modified unsaturated fatty acid glyceride | 8 |
| Self-emulsifying ester | 3 |
| Combined corrosion inhibitor | 0.3 |
| Parahydroxybenzoate ester | 0.5 |
| Polyether modified silicone defoaming agent | 0.1 |
| Water | 43.6 |

The organic alcohol amine, boric acid, ethylenediamine tetraacetic acid, dodecanedioic acid, tricarboxylic acid rust inhibitor, and water (24.1 g) in Table 2 were mixed, heated to 60 °C for reaction at a stirring rotation speed of 100 rpm/min. The reaction lasted for 45 min, and the heating was stopped. Subsequently, amidation-modified unsaturated fatty acid glyceride, self-emulsifying ester, and combined corrosion inhibitor were added thereto, mixed and stirred for 45 min at a stirring rotation speed of 100 rpm/min. After the reaction, parahydroxybenzoate ester, polyether-modified silicone defoaming agent, and water (43.6 g) were added thereto, and continued to be stirred for 30 min to obtain Example 2.

### Example 3

This example provided a multi-working-condition adaptive fully synthetic cutting fluid, having the compositions shown in the following table.

TABLE 3
Compositions of Example 3

| Raw Material | Weight/g |
|---|---|
| Organic alcohol amine | 16.5 |
| Boric acid | 2 |
| Ethylenediamine tetraacetic acid | 0.3 |
| Dodecanedioic acid | 1.8 |
| Tricarboxylic acid rust inhibitor | 2.5 |
| Water | 21.4 |
| Amidation-modified unsaturated fatty acid glyceride | 10 |
| Self-emulsifying ester | 4 |
| Combined corrosion inhibitor | 0.4 |
| Ethylene glycol hemiacetal | 0.5 |
| Polyether modified silicone defoaming agent | 0.2 |
| Water | 40.5 |

The organic alcohol amine, boric acid, ethylenediamine tetraacetic acid, dodecanedioic acid, tricarboxylic acid rust inhibitor, and water (21.4 g) in Table 3 were mixed, heated to 80 °C for reaction at a stirring rotation speed of 150 rpm/min. The reaction lasted for 50 min, and the heating was stopped. Subsequently, amidation-modified unsaturated fatty acid glyceride, self-emulsifying ester, and combined corrosion inhibitor were added thereto, mixed and stirred for 55 min at a stirring rotation speed of 150 rpm/min. After the reaction, ethylene glycol hemiacetal, polyether modified silicone defoaming agent, and water (40.5 g) were added thereto, and continued to be stirred for 40 min to obtain Example 3.

### Example 4

This example provided a multi-working-condition adaptive fully synthetic cutting fluid, having the compositions shown in the following table.

TABLE 4
Compositions of Example 4

| Raw Material | Weight/g |
|---|---|
| Organic alcohol amine | 19 |
| Boric acid | 3 |
| Ethylenediamine tetraacetic acid | 0.6 |
| Dodecanedioic acid | 2 |
| Tricarboxylic acid rust inhibitor | 3 |
| Water | 16.9 |
| Amidation-modified unsaturated fatty acid glyceride | 10 |
| Self-emulsifying ester | 5 |
| Combined corrosion inhibitor | 0.5 |
| Sandan Oil | 0.5 |
| Parahydroxybenzoate ester | 1.0 |
| Polyether modified silicone defoaming agent | 0.3 |
| Water | 38.2 |

The organic alcohol amine, boric acid, ethylenediamine tetraacetic acid, dodecanedioic acid, tricarboxylic acid rust inhibitor, and water (16.9 g) in Table 4 were mixed, heated to 80 °C for reaction at a stirring rotation speed of 180 rpm/min. The reaction lasted for 35 min, and the heating was stopped. Subsequently, amidation-modified unsaturated fatty acid glyceride, self-emulsifying ester, and combined corrosion inhibitor were added thereto, mixed and stirred for 45 min at a stirring rotation speed of 180 rpm/min. After the reaction, Sandan oil, parahydroxybenzoate ester, polyether modified silicone defoaming agent, and water (38.2 g) were added thereto, and continued to be stirred for 30 min to obtain Example 4.

### Example 5

This example provided a multi-working-condition adaptive fully synthetic cutting fluid, having the compositions shown in the following table.

TABLE 5
Compositions of Example 5

| Raw Material | Weight/g |
|---|---|
| Organic alcohol amine | 17 |
| Boric acid | 3 |
| Ethylenediamine tetraacetic acid | 0.7 |
| Dodecanedioic acid | 2 |
| Tricarboxylic acid rust inhibitor | 3.5 |
| Water | 18.3 |
| Amidation-modified unsaturated fatty acid glyceride | 11 |
| Self-emulsifying ester | 6 |
| Combined corrosion inhibitor | 0.6 |
| Sandan Oil | 0.9 |
| Ethylene glycol hemiacetal | 0.6 |
| Polyether modified silicone defoaming agent | 0.3 |
| Water | 36.1 |

The organic alcohol amine, boric acid, ethylenediamine tetraacetic acid, dodecanedioic acid, tricarboxylic acid rust inhibitor, and water (18.3 g) in Table 5 were mixed, heated to 70 °C for reaction at a stirring rotation speed of 80 rpm/min. The reaction lasted for 45 min, and the heating was stopped. Subsequently, amidation-modified unsaturated fatty acid glyceride, self-emulsifying ester, and combined corrosion inhibitor were added thereto, mixed and stirred for 50 min at a stirring rotation speed of 80 rpm/min. After the reaction, Sandan oil, ethylene glycol hemiacetal, polyether modified silicone defoaming agent, and water (36.1 g) were added thereto, and continued to be stirred for 40 min to obtain Example 5.

### Example 6

This example provided a multi-working-condition adaptive fully synthetic cutting fluid, having the compositions shown in the following table.

TABLE 6
Compositions of Example 6

| Raw Material | Weight/g |
|---|---|
| Organic alcohol amine | 19 |
| Boric acid | 2.5 |
| Ethylenediamine tetraacetic acid | 0.8 |
| Dodecanedioic acid | 3 |
| Tricarboxylic acid rust inhibitor | 4 |
| Water | 15.2 |
| Amidation-modified unsaturated fatty acid glyceride | 12 |
| Self-emulsifying ester | 6 |
| Combined corrosion inhibitor | 0.8 |
| Sandan Oil | 0.2 |
| Parahydroxybenzoate ester | 0.3 |
| Ethylene glycol hemiacetal | 0.5 |
| Polyether modified silicone defoaming agent | 0.5 |
| Water | 35.2 |

The organic alcohol amine, boric acid, ethylenediamine tetraacetic acid, dodecanedioic acid, tricarboxylic acid rust inhibitor, and water (15.2 g) in Table 6 were mixed, heated to 50 °C for reaction at a stirring rotation speed of 90 rpm/min. The reaction lasted for 35 min, and the heating was stopped. Subsequently, amidation-modified unsaturated fatty acid glyceride, self-emulsifying ester, and combined corrosion inhibitor were added thereto, mixed and stirred for 30 min at a stirring rotation speed of 80 rpm/min. After the reaction, Sandan oil, parahydroxybenzoate ester, ethylene glycol hemiacetal, polyether modified silicone defoaming agent, and water (35.2 g) were added thereto, and continued to be stirred for 40 min to obtain Example 6.

### Preparation of Metal Cutting Fluids in Comparative Examples 1-2

They were obtained by mixing, according to the formulas in Table 7, the compositions (i.e., Example 1 and Example 2 in the patent with publication number CN 104403769 A mentioned in Background Art).

TABLE 7
Formulas of Metal Cutting Fluids in Comparative Examples 1-2

| | Comparative | Comparative |
|---|---|---|
| Raw Material | Example 1 | Example 2 |
| Mineral oil | 30 | 33 |
| Triethanolamine | 5 | 7 |
| Lauryl alcohol polyoxyethylene ether | 3 | 5 |
| Rust inhibitor | 10 | 12 |
| Lubricant | 1 | 3 |
| Sterilizing agent | 1 | 2 |
| Corrosion Inhibitor | 0.5 | 0.7 |
| pH Adjuster | 1 | 2 |
| water | 48.5 | 35.3 |

### Comparative Example 3

The self-emulsifying ester and the combined corrosion inhibitor in Example 6 were replaced by equal amounts of polyether and benzotriazole. The specific formula is shown in the following table.

TABLE 8
Formula of Metal Cutting Fluid in Comparative Example 3

| Raw Material | Weight/g |
|---|---|
| Organic alcohol amine | 19 |
| Boric acid | 2.5 |
| Ethylenediamine tetraacetic acid | 0.8 |
| Dodecanedioic acid | 3 |
| Tricarboxylic acid rust inhibitor | 4 |
| Water | 15.2 |
| Amidation-modified unsaturated fatty acid glyceride | 12 |
| Polyether | 6 |
| Benzotriazole | 0.8 |
| Sandan Oil | 0.2 |
| Parahydroxybenzoate ester | 0.3 |
| Ethylene glycol hemiacetal | 0.5 |
| Polyether modified silicone defoaming agent | 0.5 |
| Water | 35.2 |

TABLE 9
Performance test results of Examples 1-6 and Comparative Examples 1-3:

| | | | | | | | | Compar- | Compar- | Compar- |
|---|---|---|---|---|---|---|---|---|---|---|
| | | | | | | | | ative | ative | ative |
| GB 6144/2010 | | Exam- | Exam- | Exam- | Exam- | Exam- | Exam- | Exam- | Exam- | Exam- |
| Test item | | ple 1 | ple 2 | ple 3 | ple 4 | ple 5 | ple 6 | ple 3 | ple 2 | ple 3 |
| Concentrate | Liquid | qualified | qualified | qualified | qualified | qualified | qualified | qualified | qualified | qualified |
| | appearance: | | | | | | | | | |
| | no | | | | | | | | | |
| | stratification, | | | | | | | | | |
| | no | | | | | | | | | |
| | precipitation, | | | | | | | | | |
| | uniform liquid | | | | | | | | | |
| | Storage | qualified | qualified | qualified | qualified | qualified | qualified | qualified | qualified | qualified |
| | stability: no | | | | | | | | | |
| | stratification, | | | | | | | | | |
| | phase change | | | | | | | | | |
| | and gelatin | | | | | | | | | |
| Diluted | Transparency | trans- | trans- | trans- | trans- | trans- | trans- | trans- | trans- | trans- |
| solution | | parent | parent | parent | parent | parent | parent | parent | parent | parent |
| | pH value | 8.5 | 8.7 | 8.9 | 9.4 | 8.4 | 9.3 | 8.7 | 8.5 | 8.9 |
| | 8.0~10.0 | | | | | | | | | |
| | Defoaming | 0.8 | 0.6 | 0.5 | 0.5 | 0.3 | 0.2 | 1.8 | 2 | 0.5 |
| | property/ | | | | | | | | | |
| | (mL/10 min) | | | | | | | | | |
| | not more than | | | | | | | | | |
| | 2 | | | | | | | | | |
| | Surface | 31.2 | 29.5 | 30.7 | 31.3 | 29.8 | 28.2 | 35.4 | 34.6 | 30.9 |
| | tension/ | | | | | | | | | |
| | (mN/m) | | | | | | | | | |
| | not more than | | | | | | | | | |
| | Corrosion test | | | | | | | | | |
| | (55 °C ± 2 °C | | | | | | | | | |
| | First-class | Grade A | Grade A | Grade A | Grade A | Grade A | Grade A | Grade A | Grade A | Grade A |
| | grey cast iron, | | | | | | | | | |
| | 24 h, not less | | | | | | | | | |
| | than Grade A | | | | | | | | | |
| | Red copper, 8 | Grade A | Grade A | Grade A | Grade A | Grade A | Grade A | Grade A | Grade A | Grade A |
| | h, not less | | | | | | | | | |
| | than Grade A | | | | | | | | | |
| | LY12 | Grade B | Grade B | Grade B | Grada B | Grade B | Grade A | Grade D | Grade C | Grade B |
| | aluminum, 8 h, | | | | | | | | | |
| | not less than | | | | | | | | | |
| | Grade B | | | | | | | | | |
| | Rust inhibition | | | | | | | | | |
| | test (35 °C ± 2 °C | | | | | | | | | |
| | Single piece, | qualified | qualified | qualified | qualified | qualified | qualified | qualified | qualified | qualified |
| | 24 h | | | | | | | | | |
| | Laminated | qualified | qualified | qualified | qualified | qualified | qualified | qualified | qualified | qualified |
| | piece, 4 h | | | | | | | | | |
| | Maximum | 542N | 571N | 583N | 596N | 612N | 633N | 470N | 492N | 574N |
| | nonseizure | | | | | | | | | |
| | load P₈ | | | | | | | | | |
| | value/N | | | | | | | | | |
| | not less than | | | | | | | | | |
| | 200N | | | | | | | | | |
| | Adaptability to | qualified | qualified | qualified | qualified | qualified | qualified | qualified | qualified | qualified |
| | machine tool | | | | | | | | | |
| | paint: allowing | | | | | | | | | |
| | slight gloss | | | | | | | | | |
| | loss and | | | | | | | | | |
| | discoloration, | | | | | | | | | |
| | but not | | | | | | | | | |
| | allowing | | | | | | | | | |
| | bubbling, | | | | | | | | | |
| | cracking and | | | | | | | | | |
| | peeling of the | | | | | | | | | |
| | paint | | | | | | | | | |
| | NO₂⁺ | 0 | 0 | 0 | 0 | 0 | 0 | 0 | 0 | 0 |
| | concentration | | | | | | | | | |
| | detection | | | | | | | | | |

As shown in Table 9, the multi-working-condition adaptive cutting fluids of Examples 1-6 prepared according to the proportioning of the present disclosure each have a maximum nonseizure load Pb value greater than 540 N, and after a 10-min defoaming test, each have the residual foam of less than 1 ml on the interface. In addition, the cutting fluid in which the self-emulsifying ester and the combined corrosion inhibitor in Example 6 are replaced by polyether and benzotriazole (Comparative Example 3) is significantly inferior to Example 6 in terms of the maximum nonseizure PB value and the corrosion inhibition effect on aluminum. Meanwhile, the environmentally friendly cutting fluids in Comparative Examples 1-2 have the maximum nonseizure load, surface tension and defoaming property significantly lower than those in Examples and Comparative Example 3, and have relatively strong corrosion to LY12 aluminum alloy.

Although the embodiments of the present disclosure have been disclosed above, they are not limited to the applications listed in the description and the embodiments. They may be applied to various fields suitable for the present disclosure. For those familiar with the art, additional modifications may be easily realized. Therefore, without departing from the general concept defined by the claims and the equivalent scope, the present disclosure is not limited to the specific details and the illustrations shown and described herein.

1. A multi-working-condition adaptive fully synthetic cutting fluid, comprising following raw materials in parts by weight:
organic alcohol amine 12-20 parts
boric acid 1-3 parts
ethylenediamine tetraacetic acid 0.3-0.8 parts
dodecanedioic acid 1-3 parts
tricarboxylic acid rust inhibitor 1-4 parts
amidation-modified unsaturated fatty acid glyceride 6-12 parts
emulsified lubricant 2-8 parts
combined corrosion inhibitor 0.2-0.8 parts
sterilizing agent 0.5-3 parts
polyether modified silicone defoaming agent 0.1-0.5 parts
water 50-75 parts.

2. The multi-working-condition adaptive fully synthetic cutting fluid according to claim 1, wherein the organic alcohol amine consists of triethanolamine and monoethanolamine in a weight ratio of 1:0.2-0.4.

3. The multi-working-condition adaptive fully synthetic cutting fluid according to claim 2, wherein a weight ratio of the boric acid to monoethanolamine is 1:1-1.5.

4. The multi-working-condition adaptive fully synthetic cutting fluid according to claim 1, wherein the emulsified lubricant is a self-emulsifying ester of fatty acid polyethylene glycol ester type, having a molecular structure containing ester group and carboxyl group.

5. The multi-working-condition adaptive fully synthetic cutting fluid according to claim 1, wherein the combined corrosion inhibitor consists of, by weight percentage, a copper corrosion inhibitor benzotriazole 40%, and aluminum corrosion inhibitors octylphosphonic acid 30% and siloxane ketone 30%.

6. The multi-working-condition adaptive fully synthetic cutting fluid according to claim 1, wherein the sterilizing agent is one or more selected from the group consisting of Sandan oil, parahydroxybenzoate ester and ethylene glycol hemiacetal.

7. A preparation method for the multi-working-condition adaptive fully synthetic cutting fluid according to claim 1, comprising following steps:
Step A, taking and mixing, by weight parts, 12-20 parts of organic alcohol amine, 1-3 parts of boric acid, 0.3-0.8 parts of ethylenediamine tetraacetic acid, 1-3 parts of dodecanedioic acid, 1-4 parts of tricarboxylic acid rust inhibitor, and 15-30 parts of water, pouring into a reactor, heating to 50-80 °C, and starting stirring with a stirring rotation speed of 70-200 rpm/min, and reacting for 30-60 min to obtain a mixture A;
Step B: mixing the mixture A prepared in Step A, 6-12 parts of amidation-modified unsaturated fatty acid glyceride, 2-8 parts of emulsified lubricant, and 0.2-0.8 parts of combined corrosion inhibitor, and stirring for 30-60 min at a stirring rotation speed of 70-200 rpm/min to obtain a mixture B; and
Step C: mixing the mixture B prepared in Step B, 0.5-3 parts of sterilizing agent, 0.1-0.5 parts of polyether modified silicone defoaming agent, and 35-45 parts of water, and stirring for 30-60 min at a stirring rotation speed of 70-200 rpm/min to obtain a target product, the multi-working-condition adaptive fully synthetic cutting fluid.

8. The preparation method according to claim 7, wherein the organic alcohol amine consists of triethanolamine and monoethanolamine in a weight ratio of 1:0.2-0.4.

9. The preparation method according to claim 8, wherein a weight ratio of the boric acid to monoethanolamine is 1:1-1.5.

10. The preparation method according to claim 7, wherein the emulsified lubricant is a self-emulsifying ester of fatty acid polyethylene glycol ester type, having a molecular structure containing ester group and carboxyl group.

11. The preparation method according to claim 7, wherein the combined corrosion inhibitor consists of, by weight percentage, a copper corrosion inhibitor benzotriazole 40%, and aluminum corrosion inhibitors octylphosphonic acid 30% and siloxane ketone 30%.

12. The preparation method according to claim 7, wherein the sterilizing agent is one or more selected from the group consisting of Sandan oil, parahydroxybenzoate ester and ethylene glycol hemiacetal.
